(19) United States
(12) Patent Application Publication
(10) Pub. No.: US 2014/0141752 A1
(43) Pub. Date: May 22, 2014

(54) SELF-RECORDED OUTGOING MESSAGING

(71) Applicant: VARIOUS VENTURES, INC., Cockeysville, MD (US)

(72) Inventor: Gary Olschansky, Cockeysville, MD (US)

(73) Assignee: VARIOUS VENTURES, INC., Cockeysville, MD (US)

(21) Appl. No.: 13/681,710

(22) Filed: Nov. 20, 2012

(51) Int. Cl. H04W 4/12

(52) U.S. Cl. CPC H04W 4/12
USPC 455/412.1

(57) ABSTRACT

Self-recorded outgoing messaging systems are described. A messaging system may include a caller device and a server. The caller device may be configured to send a message prepared by a user to the server for storage. The server may be configured to receive and store the message from the caller device for later transmission to one or more callees. The caller device may be configured to request for the server to send the message stored on the server to one or more callees. Responsive to the request, the server may be configured to send the message to the one or more callees and to send a notification to the caller device that the message was sent to the one or more callees.

### FIELD

The present invention generally pertains to voicemail and messaging, and more specifically, to a self-recorded outgoing messaging system.

### BACKGROUND

Various voicemail systems are known that provide a user with access to voicemail messages. For instance, callers may access voicemail messages that have been left by other callers, convert voicemail to text, or email voicemail notifications to callees. However, callers do not record and save their own voicemail messages prior to sending, nor do callers receive email notifications pertaining to their own recorded voicemail messages or that their self-recorded messages are ready to use.

### SUMMARY

Certain embodiments of the present invention may be implemented and provide solutions to the problems and needs in the art that have not yet been fully solved by conventional voicemail and messaging systems. For example, some embodiments of the present invention enable a caller to save and edit outgoing voicemail messages prior to sending, send the message when the message is ready for sending, and receive email copies of messages after sending.

In one embodiment of the present invention, a computer program is embodied on a non-transitory computer-readable medium. The computer program is configured to cause at least one processor to receive and store an audio or text message from a user for later transmission to one or more callees and to receive a request from the user to send the message to the one or more callees. The computer program is also configured to cause the at least one processor to send the message to the one or more callees and to send a notification to the user that the message was sent to the one or more callees.

In another embodiment of the present invention, a computer-implemented method includes sending a message prepared by a user, from a computing system, to a server for storage. The computer-implemented method also includes requesting, by the computing system, for the server to send the message stored on the server to one or more callees, and receiving a notification from the server, at the computing system, that the message was sent to the one or more callees.

In yet another embodiment of the present invention, a system includes a caller device and a server. The caller device is configured to send a message prepared by a user to the server for storage. The server is configured to receive and store the message from the caller device for later transmission to one or more callees. The caller device is configured to request for the server to send the message stored on the server to one or more callees. Responsive to the request, the server is configured to send the message to the one or more callees and to send a notification to the caller device that the message was sent to the one or more callees.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates an architectural diagram of a system, according to an embodiment of the present invention.

FIG. 2 illustrates an architectural diagram of a system, according to an embodiment of the present invention.

FIG. 3 illustrates a front view of a mobile phone running a stand-alone messaging application, according to an embodiment of the present invention.

FIG. 4 is a flowchart illustrating a method for recording, transferring, and processing messages, according to an embodiment of the present invention.

FIG. 5 is a timing diagram illustrating communication between client, server, and callee systems, according to an embodiment of the present invention.

FIG. 6 is a flowchart illustrating a caller device method for messaging, according to an embodiment of the present invention.

FIG. 7 is a flowchart illustrating a server method for messaging, according to an embodiment of the present invention.

FIG. 8 illustrates a computing system, according to an embodiment of the present invention.

### DETAILED DESCRIPTION OF THE EMBODIMENTS

Some embodiments of the present invention pertain to a self-recorded outgoing messaging system that allows callers to record and save messages (e.g., text or voicemail) prior to sending the messages so the content thereof can be reviewed and edited, and users are certain that they are sending the desired message content. This may enable users to store messages they have left for recipients without the need to access the callee's voicemail system, although some embodiments may do so. In some embodiments, a voicemail message may be converted to text for editing by a user, received by a callee as text from the caller and converted to an audio recording for transmission, or sent in text form to a callee's system for conversion to an audio recording. Once sent, messages may be changed from an editable state to a locked state to preserve the content of messages that were actually sent.

In some embodiments, both the text and a recording of the message are saved for future use, and also potentially to prove that the message was left by the caller. The technology may be implemented, for instance, as a stand-alone application on a smartphone or a hardware Voice over Internet Protocol (“VoIP”) phone, or as an enterprise application with a client/server architecture, for example. In client/server embodiments, the recording may be saved to the server, and the user may later access the message to listen to the recording and/or view the text of the message. The user (e.g., a caller) may also receive notifications via email that a message has been left for a callee, and may receive the content thereof. This feature may appear counterintuitive outside of the context of some embodiments of the present invention given that the caller knows when he or she left a voicemail message, and as such, would likely not be expecting email notification in this regard.

In certain embodiments, messages may be linked to an account, a file, a docket number, a group of callers, or by any other mechanism that allows messages to be associated. In this manner, other employees may review messages prior to sending, and furthermore, associated messages may be grouped and stored in an appropriate file for data retention and record keeping purposes. For instance, in the context of a law practice, a lawyer's assistant may create a draft message to send to a client, and the lawyer may edit the message prior to sending or approving the message for sending. In some embodiments, the system may only allow certain users to access grouped messages. Thus, various levels of access and security may be created.

Some areas where certain embodiments may be especially beneficial include, but are not limited to, the legal field, where it is often important to be able to definitively demonstrate what another party knew at what time, and/or that various notices were actually delivered. Accordingly, a feature of such embodiments may be the ability to store voicemail messages in a manner that is accessible and retrievable by the caller for verification purposes. Further, some embodiments may notify the caller that a message has been left and stored, and the caller may potentially be provided with the content of the message.

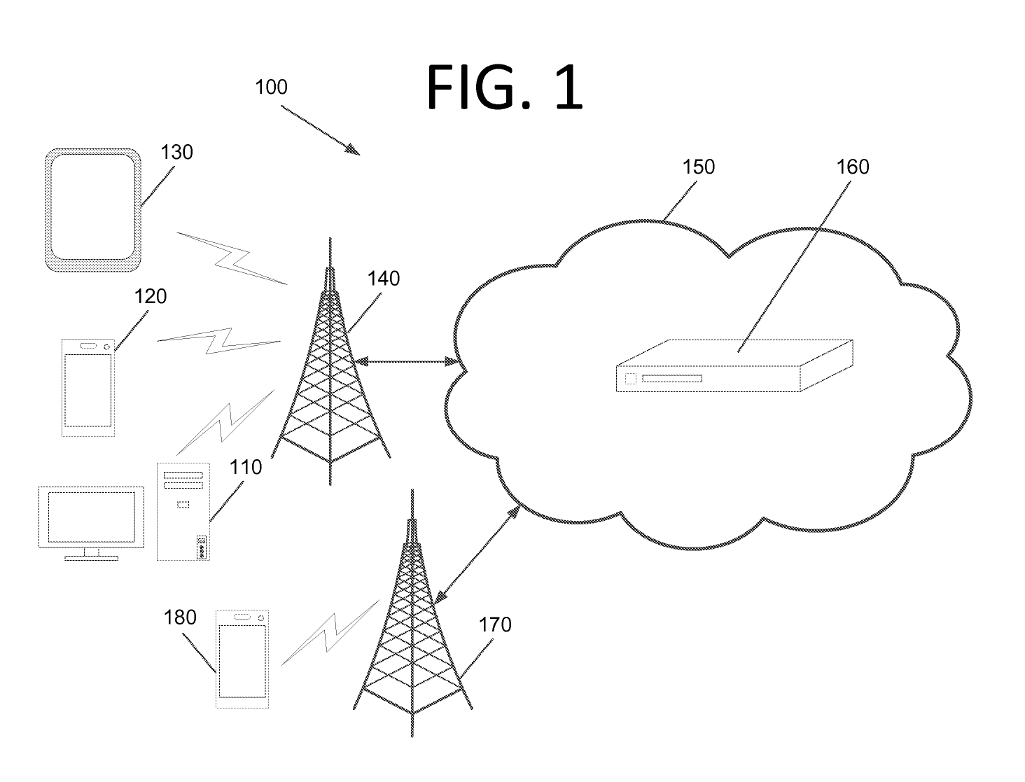

FIG. 1 illustrates an architectural diagram of a system 100, according to an embodiment of the present invention. System 100 includes a personal computer 110, a mobile phone 120, a tablet computer 130, a first base station 140, a telecommunications network 150, a server 160, a second base station 170, and a callee mobile phone 180. Each of personal computer 110, mobile phone 120, and tablet computer 130 may belong to a single user or to different users for enterprise/group implementations. While the communications here are shown as wireless, in some embodiments, wired communications may also be used for one or more of the communication links. In this embodiment, a client-side messaging application is running on each of personal computer 110, mobile phone 120, and tablet computer 130, and a server-side messaging application is running on server 160. However, in stand-alone embodiments, as discussed later, functionality may be implemented on a single device.

A user may record and/or type one or more outgoing messages using one or more of personal computer 110, mobile phone 120, and tablet computer 130. For instance, a user may record an entire voice message using one of these devices, prepare an entire text message using one of these devices, or create individual parts of voice and/or text messages on one or more of the devices. When multiple message parts are created, the parts may be automatically or manually assembled into a combined message using a software application running either on personal computer 110, mobile phone 120, and tablet computer 130, or via a web application provided through server 160 or another server (not shown) that is accessed by one of these devices. When a group of users exists, certain permissions may need to be enabled for a user's respective account in order for that user to have permission to assemble and/or edit messages. In some embodiments, personal computer 110, mobile phone 120, and tablet computer 130 may convert voice messages to text, or vice versa, prior to sending the messages to server 160.

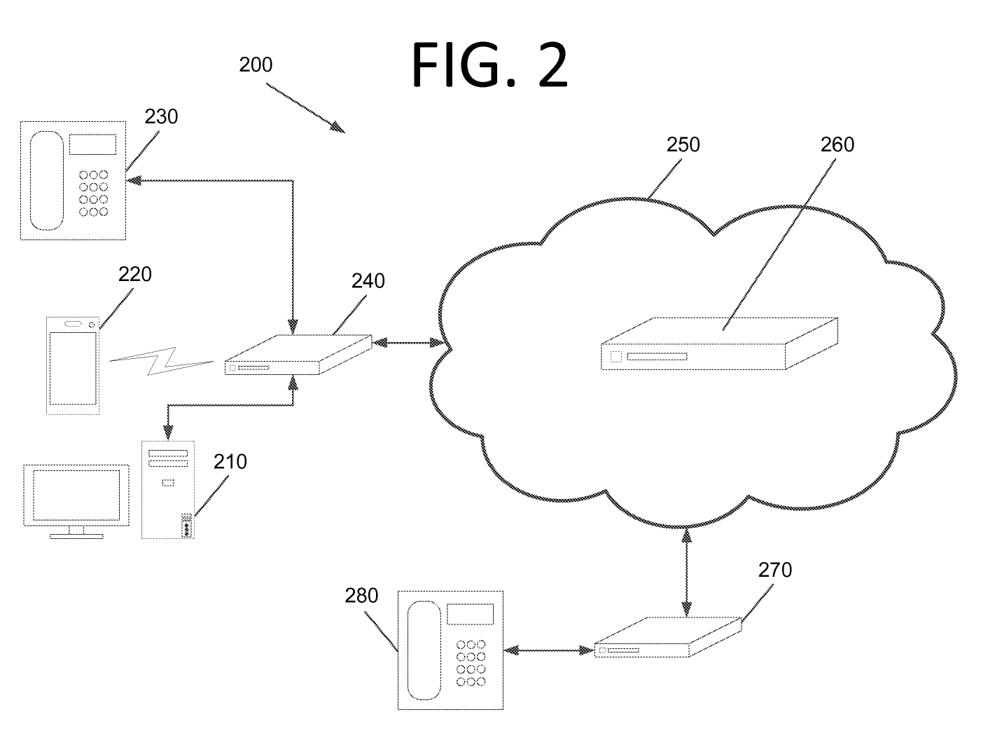

In FIG. 1, personal computer 110, mobile phone 120, and tablet computer 130 communicate with telecommunications network 150 via first base station 140. However, in some embodiments, such as that illustrated in FIG. 2, one or more of these devices may communicate via the Internet in lieu of, or in addition to, via a telecommunications network. Telecommunications network 150 may be any telecommunications network, such as those of any currently available commercial carrier or combination of carriers, and may utilize any suitable standards and technologies, such as enhanced Node Bs, Radio Network Controllers (“RNCs”), 3G, 4G, 5G (when defined and released), etc. Personal computer 110, mobile phone 120, and tablet computer 130 wirelessly communicate with first base station 140 that transmits data to, and receives data from, these devices. First base station 140, in turn, communicates with telecommunications network 150. For the sake of convenience, the details of telecommunications network 150 are abstracted here, but telecommunications network 150 may have any desired and/or commercially implemented architecture.

Within, or otherwise accessible by, telecommunications network 150 is a server 160 that stores voice/text messages. Upon receiving a voice memo, server 160 may translate the voice memo into a suitable text format (e.g., ASCII text, Unicode, entries in a relational database, etc.). Server 160 then makes the translated messages available for authorized devices to access.

Once a user with appropriate permissions approves the message for sending, the finalized message, in the form of voice or text data, is sent from server 160 via second base station 170 to callee mobile phone 180. While mobile phones are shown here, messages could naturally be transmitted to landline phones and/or various computing devices of the callee. Also, the message could be sent to multiple callees in some embodiments, and a user may select the desired callees. A notification that the message has been sent, including a voice and/or text file containing the content of the message, is also sent to one or more of personal computer 110, mobile phone 120, and tablet computer 130. In some embodiments, the notification may include a recording of a greeting from the callee with the message and/or the callee's phone number(s). After sending, server 160 may disable the ability to edit the message to ensure that an accurate record of its content is maintained. The sent messages may also be accessed from server 160 for subsequent review by authorized users.

FIG. 2 illustrates an architectural diagram of a system 200, according to an embodiment of the present invention. System 200 includes a personal computer 210, a mobile phone 220, a landline phone 230, an enterprise server 240, an Internet Protocol (“IP”) network 250, a server 260, a callee enterprise server 270, and a callee landline phone 280. Functionally, system 200 may operate in a similar manner to system 100 of FIG. 1, except that IP communications and networks are used. Further, in some embodiments, IP network 250 may interface with a telecommunications network of the caller to deliver messages. Any variants of the architectures described herein are included within the scope of this disclosure.

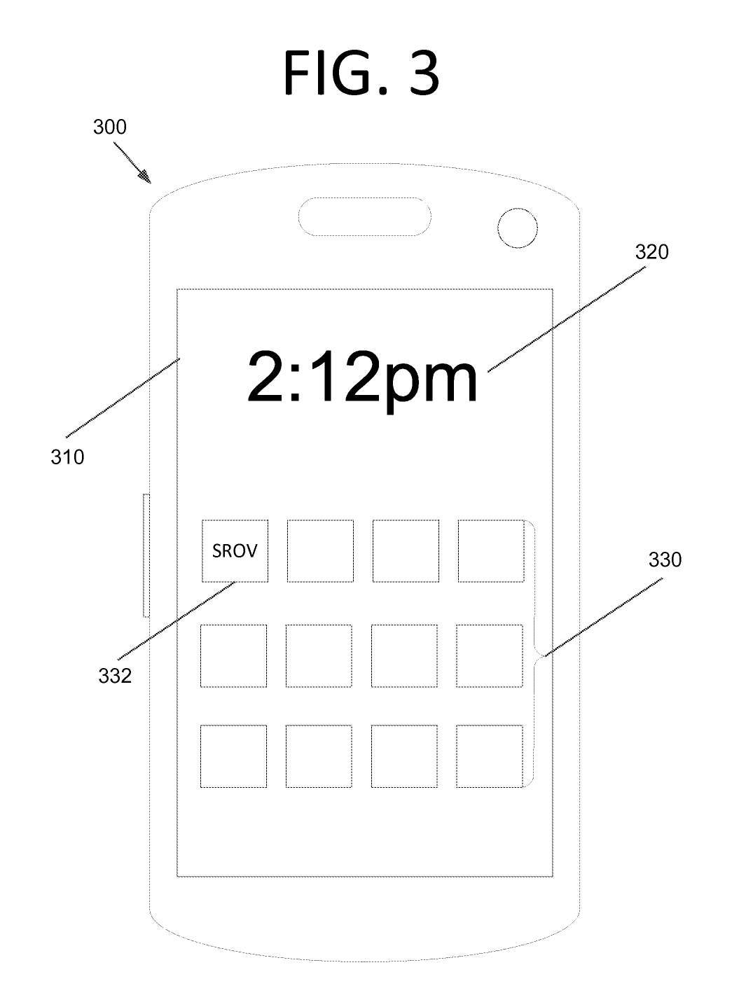

FIG. 3 illustrates a front view of a mobile phone 300 running a stand-alone messaging application, according to an embodiment of the present invention. Mobile phone 300 includes a large screen 310 as is common with many conventional smart phones. Screen 310 displays the current time 320, as well as buttons 330 for twelve software applications. One of the buttons is an SROV button 332 that launches the SROV application.

The SROV application allows the user to record and edit voice or text messages prior to sending. Upon deciding to send the message, the user touches or presses a send button or other appropriate triggering functionality in the messaging application to send the message to a callee. If needed, the messaging application may translate text into an audio file, or utilize a third party application for the translation. The callee then receives the message as voice or text. The messaging application may also send a notification to the user via email that includes an audio file of the message and/or text thereof.

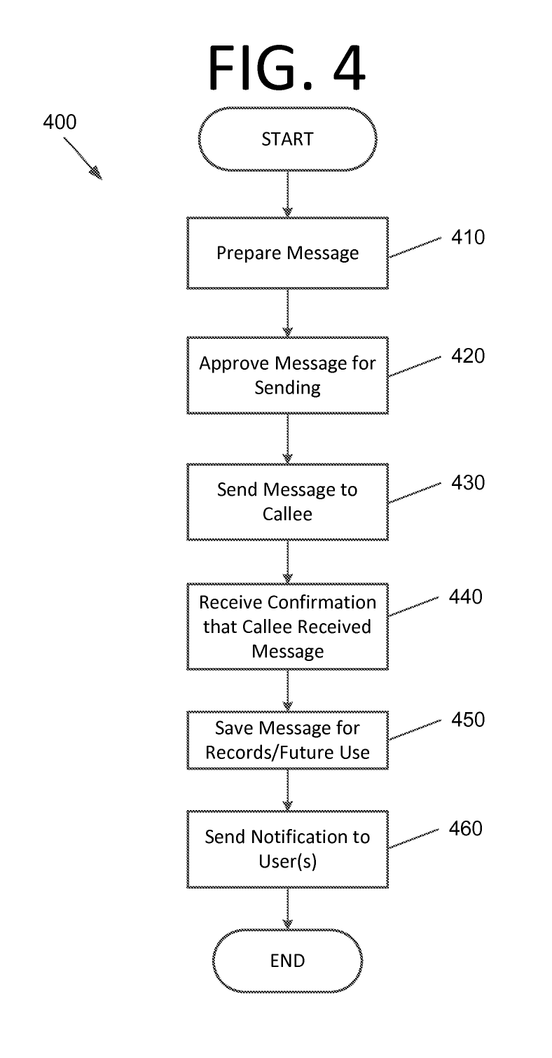

FIG. 4 is a flowchart 400 illustrating a method for recording, transferring, and processing messages, according to an embodiment of the present invention. In some embodiments, the method of FIG. 4 may be implemented by system 100 of FIG. 1, for example. The method begins with preparing a message prior to sending at 410. In single user embodiments, this may be as simple are recording a voice message or providing a text message to a client-side or server-side software application, depending on whether the embodiment is a stand-alone or client-server implementation. The user may also store multiple voice and/or text messages (some embodiments can store and process both) for later editing and/or assembling.

In multi-user embodiments, a user may store a voice and/or text message, which may be subsequently reviewed and edited by another user, such as a manager or other reviewing employee. However, multi-user embodiments may apply to any group of users and are not limited to business/enterprise applications. Furthermore, in some embodiments, different users may add/edit messages in a collaborative fashion.

In some multi-user embodiments, once a message is in a desired form, a user with appropriate permissions may approve the message for sending to a callee at 420. The user may do this by pressing a “finalize” button on the client-side software application, for instance, and the message may be locked from further editing. In single user, stand-alone embodiments, this step may not be necessary. The message is then sent to the callee at 430 when the user presses a “send” button, for example. In certain embodiments, the message may be sent to multiple callees. Furthermore, the message may be sent in voice and/or text form, and some embodiments allow the user to select the format in which the message is sent. However, some embodiments support only voice messages and other embodiments only support sending text messages.

Once the message has been sent, in some embodiments, the stand-alone application or server-side application receives a confirmation that the message has been received from the callee's system at 440. The message is then stored for record keeping and/or future use at 450. The message may be stored on a user's device, a server, a relational database, and/or on any other suitable device.

The user(s) then receive a notification that the message was received by the callee at 460. The notification may be sent by email, text, posted to a website, etc. Where supported, some embodiments may also include the text content of the message and/or a voice recording thereof, either in the voice of the user(s) or machine translated. In addition to, or in lieu of, such an attachment, some embodiments may provide an email notification that contains a link to the message content. In this manner, the user(s) can access the message to review what was sent at a later time. In some embodiments, the notification may include a recording of a greeting from the callee with the message and/or the callee's phone number(s).

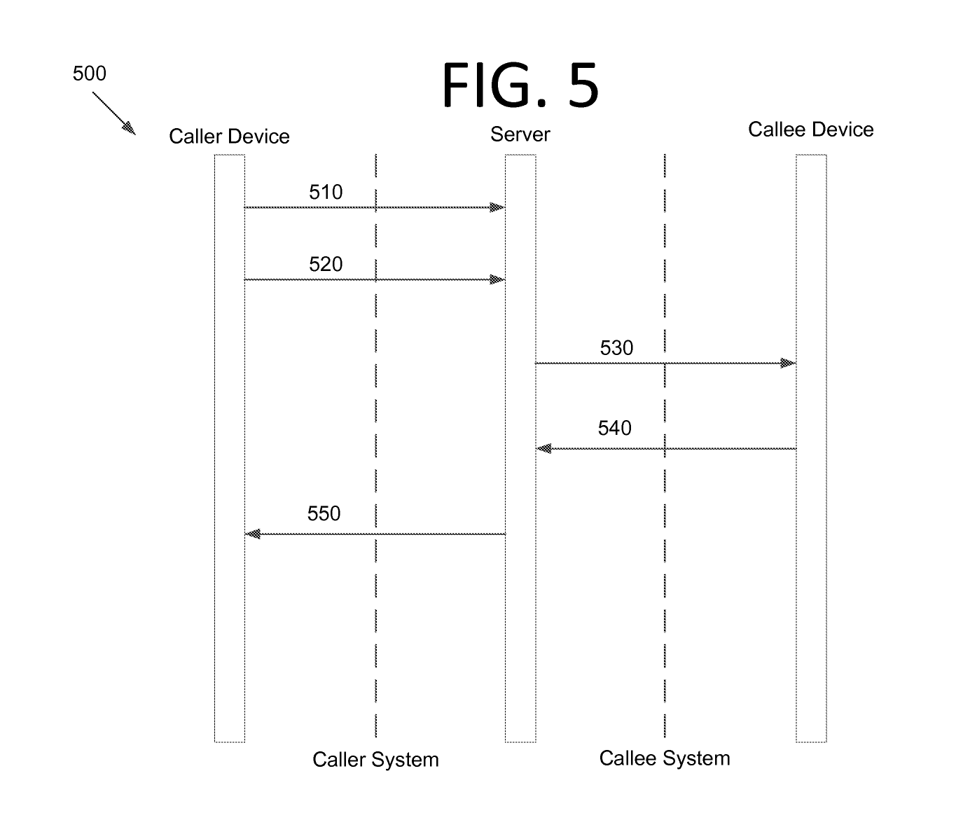

FIG. 5 is a timing diagram 500 illustrating communication between client, server, and callee systems, according to an embodiment of the present invention. The dashed lines represent, and abstract, the various architectural components of the caller and callee systems required for facilitating communication between the caller device, the server, and the callee device. The communications illustrated in FIG. 5 are by way of example only, and different communications and/or a subset of the communications shown in FIG. 5 may be used in various embodiments.

The caller device (i.e., user device) sends a request to store a message in voice and/or text format to the server for storage at 510. When the caller is satisfied with the message, the caller sends a request to the server to send the message to the callee at 520. The server then sends the message in voice and/or text form to the callee device at 530. In some embodiments, the server may translate an audio message to text, or vice versa, prior to sending.

The callee device then provides an acknowledgement to the server that the message was received at 540. After receiving the acknowledgement, the server sends a notification to the caller device that the message was received by the callee at 550. The notification may include text and/or audio of the message.

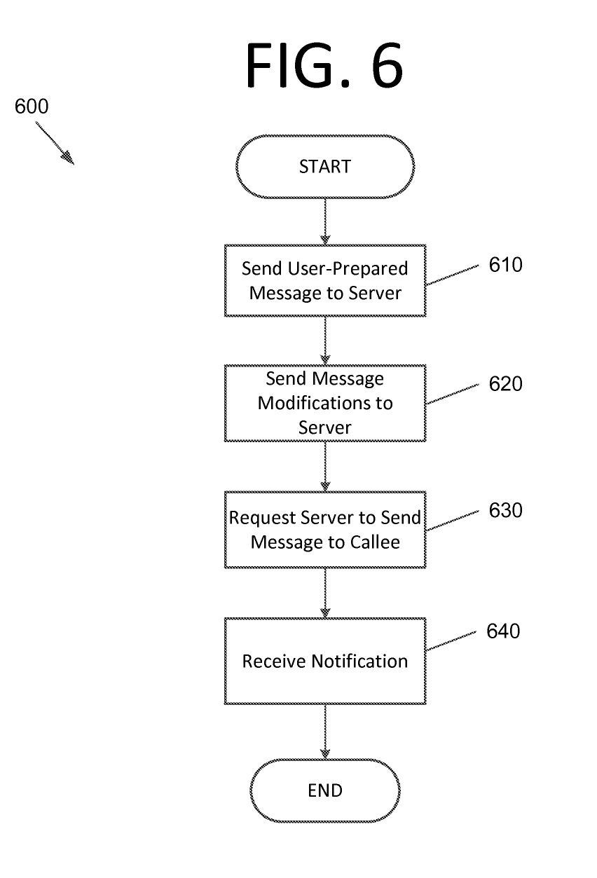

FIG. 6 is a flowchart 600 illustrating a caller device method for messaging, according to an embodiment of the present invention. The method begins with sending a message prepared by a user to a server for storage at 610. In certain embodiments, the message may be converted by the caller device from text to audio, or from audio to text, prior to sending the message to the server. The message may include audio, text, or both. The caller device then sends modifications to the message to the server at 620. Next, the caller device requests for the server to send the message stored on the server to one or more callees at 630. After sending the message, the caller device receives a notification from the server that the message was sent to the one or more callees at 640. In some embodiments, the notification includes a date and time that the message was received by the one or more callees. The notification may include text of the message, audio of the message, or both.

A group of users may have permission to store messages on the server, and at least one user of the group of users may have permission to modify or append the messages and approve the messages for sending. The message may include audio or text.

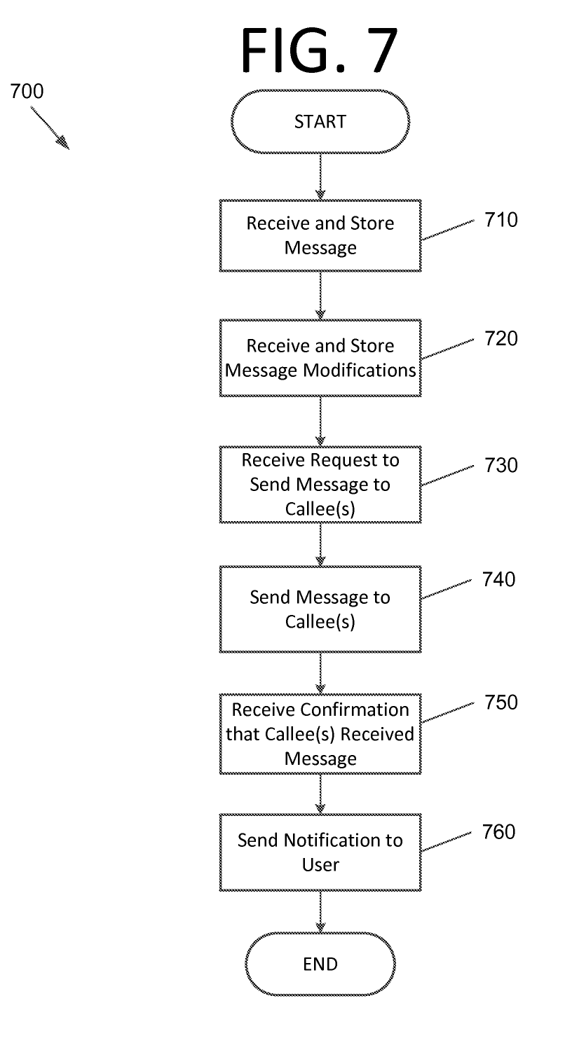

FIG. 7 is a flowchart 700 illustrating a server method for messaging, according to an embodiment of the present invention. The method begins with receiving and storing an audio or text message from a user for later transmission to one or more callees at 710. The server then receives modifications to the message from the user prior to sending at 720, and the server modifies the message accordingly.

Next, the server receives a request from the user to send the message to the one or more callees at 730. Responsive thereto, the server sends the message to the one or more callees at 740. The server then receives an acknowledgement from the callee(s) that the message was received at 750. Thereafter, the server sends a notification to the user that the message was sent to the one or more callees at 760. The notification may include text of the message, audio of the message, or both. In some embodiments, a group of users has permission to store messages, and at least one of the group of users has permission to modify or append the messages and approve the messages for sending. In certain embodiments, the server may convert the message from text to audio, or from audio to text, prior to transmitting the message to the callee.

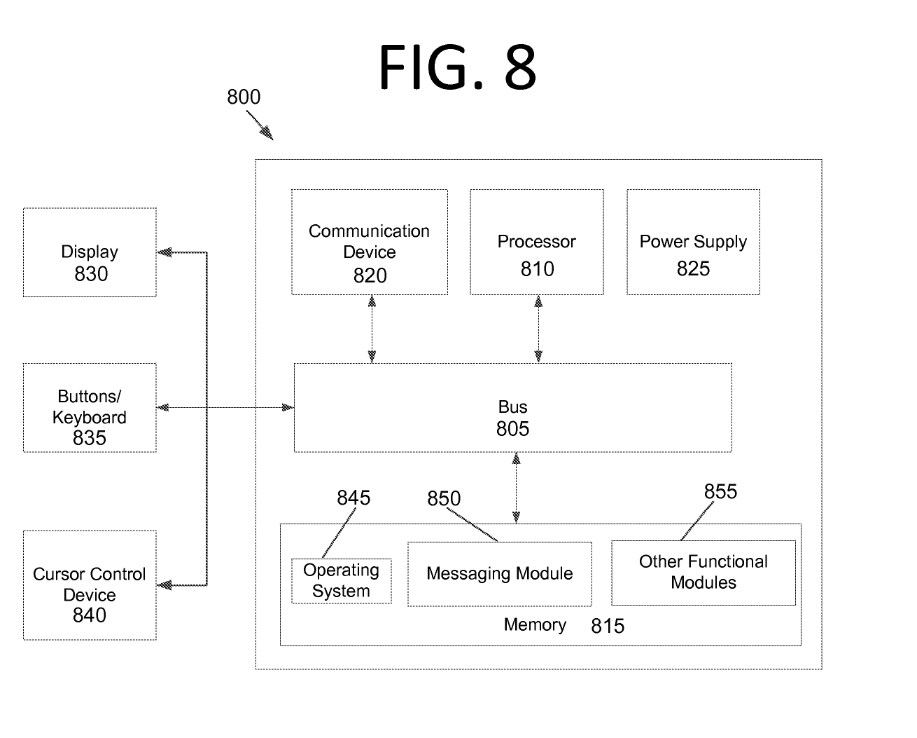

FIG. 8 illustrates a computing system 800, according to an embodiment of the present invention. Computing system may be any of the computing devices described herein. System 800 includes a bus 805 or other communication mechanism for communicating information, and a processor 810 coupled to bus 805 for processing information. Processor 810 may be any type of general or specific purpose processor, including a central processing unit (“CPU”) or application specific integrated circuit (“ASIC”). System 800 further includes a memory 815 for storing information and instructions to be executed by processor 810. Memory 815 can be comprised of any combination of random access memory (“RAM”), read only memory (“ROM”), flash memory, cache, static storage such as a magnetic or optical disk, or any other types of non-transitory computer-readable media or combinations thereof. Additionally, system 800 includes a communication device 820, such as a transceiver, to wirelessly provide access to a telecommunications network. A power supply 825, such as a battery or adapter for an alternating current or direct current power source, provides power to system 800.

Non-transitory computer-readable media may be any available media that can be accessed by processor 810 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 810 is further coupled via bus 805 to a display 830, such as a Liquid Crystal Display (“LCD”), for displaying information to a user. For certain computing systems, such as simpler versions of a recording device, a display may not be present. Buttons/keyboard 835 and a cursor control device 840, such as a computer mouse or a touch pad, are further coupled to bus 805 to enable a user to interface with system 800. However, in certain embodiments such as those for mobile computing implementations, a physical keyboard and mouse may not be present, and the user may interact with the device solely through display 830, buttons, and/or a touchpad (not shown). Any type and combination of input devices may be used as a matter of design choice.

In one embodiment, memory 815 stores software modules that provide functionality when executed by processor 810. The modules include an operating system 845 for system 800. The modules further include a messaging module 850 that is configured to perform the appropriate SROV functionality for system 800. System 800 may include one or more additional functional modules 855 that include additional functionality.

One skilled in the art will appreciate that a “system” could be embodied as a personal computer, a server, a console, a personal digital assistant (“PDA”), a mobile phone, a tablet computing device, a recording device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a non-transitory computer-readable medium, which may be, for instance, a hard disk drive, flash device, random access memory (“RAM”), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method steps performed in FIGS. 4, 6, and 7 may be performed by a computer program, encoding instructions for the nonlinear adaptive processor to perform at least the methods described in FIGS. 4, 6, and 7, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 4, 6, and 7, which may also be stored on the non-transitory computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

Throughout this disclosure, the terms “application” and “software application” are used. These terms are defined as an executable program that is configured to be run by a computing system. In some cases, “application” and “software application” may be synonymous with “module”. It should be understood that pure hardware implementations, and implementations using a combination of hardware and software, may also be used, although such implementations are likely to be less flexible and more costly.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable medium, the computer program configured to cause at least one processor to:
receive and store an audio or text message from a user for later transmission to one or more callees;
receive a request from the user to send the message to the one or more callees;
send the message to the one or more callees; and
send a notification to the user that the message was sent to the one or more callees.

2. The computer program of claim 1, wherein the computer program is further configured to cause the at least one processor to:
receive an acknowledgement from the callee that the message was received.

3. The computer program of claim 1, wherein the notification comprises text of the message, audio of the message, or both.

4. The computer program of claim 1, the program further configured to cause the at least one processor to:
receive modifications to the message from the user prior to sending.

5. The computer program of claim 1, wherein a group of users has permission to store messages, and at least one of the group of users has permission to modify or append the messages and approve the messages for sending.

6. The computer program of claim 1, the program further configured to cause the at least one processor to:
convert the message from text to audio, or from audio to text, prior to transmitting the message to the callee.

7. A computer-implemented method, comprising:
sending a message prepared by a user, from a computing system, to a server for storage;
requesting, by the computing system, for the server to send the message stored on the server to one or more callees; and
receiving a notification from the server, at the computing system, that the message was sent to the one or more callees.

8. The computer-implemented method of claim 7, wherein the notification comprises a date and time that the message was received by the one or more callees.

9. The computer-implemented method of claim 7, wherein the notification comprises text of the message, audio of the message, or both.

10. The computer-implemented method of claim 7, further comprising:
sending modifications to the message, from the computing system, to the server prior to requesting for the server to send the message.

11. The computer-implemented method program of claim 7, wherein a group of users has permission to store messages on the server, and at least one of the group of users has permission to modify or append the messages and approve the messages for sending.

12. The computer-implemented method of claim 7, wherein the message comprises audio or text.

13. The computer-implemented method of claim 7, further comprising:
converting the message, by the computing system, from text to audio, or from audio to text, prior to sending the message to the server.

14. A system, comprising:
a caller device; and
a server, wherein
the caller device is configured to send a message prepared by a user to the server for storage,
the server is configured to receive and store the message from the caller device for later transmission to one or more callees,
the caller device is configured to request for the server to send the message stored on the server to one or more callees,
responsive to the request, the server is configured to send the message to the one or more callees,
and the server is configured to send a notification to the caller device that the message was sent to the one or more callees.

15. The system of claim 14, wherein the notification comprises text of the message, audio of the message, or both.

16. The system of claim 14, wherein the caller device is further configured to send modifications to the message to the server prior to requesting for the server to send the message.

17. The system of claim 14, wherein the message comprises audio or text.

18. The system of claim 14, wherein the server is further configured to receive an acknowledgement from the callee that the message was received.

19. The system of claim 14, wherein the notification comprises text of the message, audio of the message, or both.

20. The system of claim 14, wherein the server is further configured to receive modifications to the message from the caller device prior to sending.
